(19) United States
(12) Patent Application Publication
(10) Pub. No.: US 2020/0216077 A1
(43) Pub. Date: Jul. 9, 2020

(54) SYSTEMS AND METHODS FOR VEHICLE SYSTEMS CUSTOMIZATION FOR ONE OR MORE USERS OF THE VEHICLE

(71) Applicant: Byton North America Corporation, Santa Clara, CA (US)

(72) Inventors: Henrik Ferdinand Nölscher, Ulm (DE); Francisco Javier Vazquez Vidal, Ulm (DE); Abraham Tai-Yu Chen, San Jose, CA (US)

(21) Appl. No.: 16/240,456

(22) Filed: Jan. 4, 2019

(51) Int. Cl. B60W 40/08; B60W 50/08; G06F 21/31; G06F 3/0484; H04L 29/08; G06F 21/32; H04W 4/40; H04W 76/14; H04W 4/029

(52) U.S. Cl. CPC B60W 40/08; B60W 50/08; G06F 21/316; G06F 3/0484; H04L 67/306; G06F 12/0802; H04W 4/40; H04W 76/14; H04W 4/029; B60W 2040/0809; G06F 21/32

(57) ABSTRACT

Disclosed is a method and apparatus for customizing a vehicle for one or more uses of the vehicle. The method may include determining a user identifier associated with a user accessing the vehicle. The method may also include querying a remote server by the vehicle for first vehicle customization settings associated with the user identifier. Furthermore, the method may include configuring one or more systems of the vehicle in response to receipt of one or more vehicle customization settings from the remote server, the one or more vehicle customization settings being associated with the user identifier.

### FIELD

The disclosed embodiments relate generally to vehicle systems and in particular, but not exclusively, to customizing one or more systems of a vehicle for one or more users of the vehicle.

### BACKGROUND

Vehicles, such as cars, trucks, trains, etc., generally include a lock to prevent unauthorized access to the vehicle, as well as to prevent the unauthorized starting and operation of the vehicle. While such locks used to involve physical keys, more and more vehicles are using wireless entry and ignition systems. With wireless entry and ignition systems, a hardware device referred to as a key fob provides authentication data to the vehicle. When verified by the vehicle, the user is electronically granted access to the vehicle and/or the ability to start and operate the vehicle. Typically, the key fob and the vehicle continue to exchange wireless authentication data, or other signaling, so that they vehicle can ensure that the key fob, and thus the operator, are still in proximity to the vehicle during operation.

Once granted access to a vehicle, an operator and any passengers may customize various aspects of the vehicle. For example, a driver seat position may be adjusted based on the height and/or driving position preference of a particular operator of the vehicle. As another example, a climate control system temperature may be set to a specific temperature based on a preference of the same or other operator. There are a number of different systems of a vehicle that may be adjusted during use by an operator and/or vehicle passengers. However, when a vehicle is controlled by more than one operator, the settings applied to the vehicle may be changed by each usage, requiring a current operator to re-adjust various systems of the vehicle changed by a prior operator. Such re-adjustments by the current operator may be incomplete, in that a current operator may choose not to re-adjust and/or forget to adjust certain vehicle systems, therefore resulting in a less than optimal operating experience. Furthermore, the re-adjustment may not be able to re-create a preferred customization of a vehicle system, such as a seat, lumbar, mirror position, etc. resulting in the operator being in a non-optimal position during operation of the vehicle.

### BRIEF DESCRIPTION OF THE DRAWINGS

FIG. 1 is a block diagram of an exemplary system architecture for enabling customization of vehicle system(s) for one or more uses of the vehicle;

FIG. 2 is block diagram of one embodiment of a system including a vehicle, a wireless access device, and a remote customizations server in communication with one another;

FIG. 3 is a flow diagram of one embodiment of a method for performing vehicle customizations for one or more users of the vehicle; and

FIG. 4 is a flow diagram of another embodiment of a method for performing vehicle customizations using a wireless access device.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

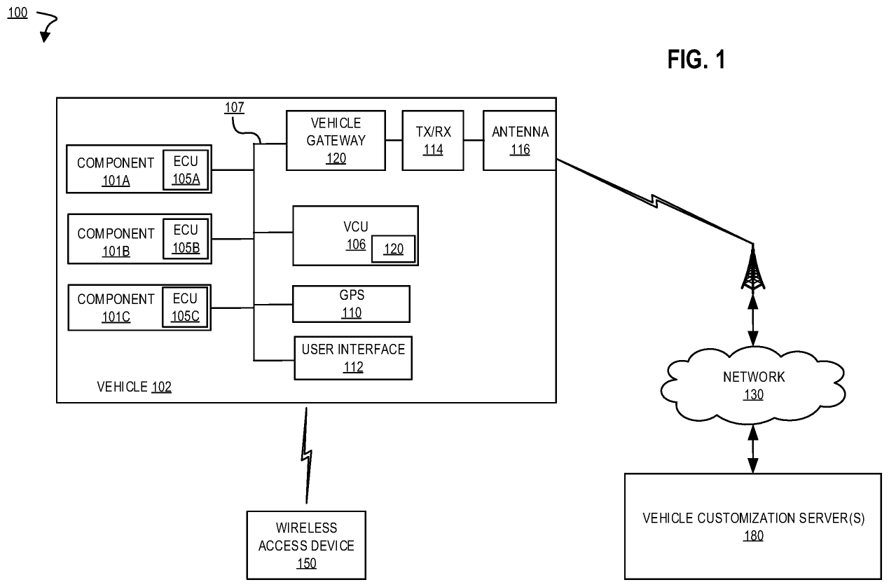

FIG. 1 is a block diagram of an exemplary system architecture 100 for enabling customization of vehicle system(s) for one or more users of the vehicle. In embodiments, system 100 illustrates a system in which processes for customizing one or more systems of vehicle 102 are performed accurately, reliably, and efficiently for example, for a user associated wireless access device 150. In embodiments, one wireless access device associated with a user can be used for customizing a vehicle 102 differently depending on whether the user is a driver, or a front or rear passenger; and more than one wireless access device may be used for customizing vehicle 102 for the same and/or different users (e.g., customizations for the driver and one or more passengers). Furthermore, wireless access device 150 may be used for customizing vehicles in addition to vehicle 102 shown. That is, a user may use their wireless access device 150 to customize any number of different vehicles prior to operation of those vehicles, provided that the other vehicles have systems with the same/similar capabilities and/or adjustments as those in vehicle 102. Furthermore, any number of different users using may use wireless access device 150 or different wireless access devices to customize the same vehicle, consistent with the discussion herein. Further, vehicle 102 may be customized for one or more users independent of the wireless access device 150 providing access to the vehicle, such as by authenticating themselves to the vehicle using, for example, facial recognition, voice recognition, biometric authentication, as well as other forms of digital recognition that enable vehicle 102 to uniquely identify different users. However, to avoid obscuring embodiments of the present disclosure, reference will be made to wireless access device 150 and vehicle 102, but should not be limited thereto.

In embodiments, system 100 includes vehicle 102, which may be a fully electric vehicle, a partially electric (i.e., hybrid) vehicle, a non-electric vehicle (i.e., vehicle with a traditional internal combustion engine), or other type of vehicle. Furthermore, although described mostly in the context of automobiles, the illustrated systems and methods can also be used in other wheeled vehicles such as trucks, motorcycles, buses, trains, etc. It can also be used in non-wheeled vehicles such as ships, airplanes (powered or gliders), and rockets. In fact, the illustrated embodiments can be used in any situation in which it is useful to customize one or more systems of a vehicle for the convenience and/or control of an operator of the vehicle.

In embodiments, system 100 further includes wireless access device 150. In embodiments, wireless access device 150 is a hardware device capable of wirelessly transmitting and receiving data, and performing one or more authentication processes including transmission of device identifier(s), as discussed in greater detail herein. Wireless access device 150, in embodiments, may be a purpose built device that's primary function is as a wireless key for providing access to, and enabling operation of, vehicle 102. In embodiments, however, wireless access device 150 may be any wireless device with a transceiver, memory, and processor configured to perform the processes discussed herein. For example, a smartphone, smart watch, wearable device, tablet computer, or other wireless computing device may be configured to perform the functions and processes discussed herein, such as by execution of an application associated with a manufacturer of vehicle 102. Further, other electronic devices (not shown) can be used by the vehicle 102 to perform one or more authentication processes, so that the user (e.g. a driver or a passenger) of the vehicle can be authenticated or recognized by the vehicle.

In embodiments, vehicle 102 may be communicatively coupled to vehicle customization server(s) 180. In the context of this application, “communicatively coupled” means coupled in such a way that data can be exchanged, in one or both directions, between two entities or components (e.g., between the motor vehicle 102 and the vehicle customization server(s) 180). Vehicle customization server(s) 180 may include a plurality of servers distributed over network 130, each being associated with and/or maintained by a manufacturer of vehicle 102 or a third party authorized by the manufacturer. Furthermore, although vehicle customization options are discussed as being stored, updated, processed, used, and/or distributed by vehicle customization server(s) 180, in embodiments, vehicle customization server(s) 180 may store, update, process, use, and/or distribute other data and/or services to vehicle 102. Thus, vehicle customization server(s) 180, in embodiments, may provide services to vehicles (e.g. vehicle 102) in addition to the vehicle system customization discussed herein.

In one embodiment, vehicle 102 includes one or more systems, such as components 101, each having an electronic control unit (ECU) 105, and each ECU 105 is communicatively coupled via a communications network 107 to a vehicle control unit (VCU) 106. The communications network 107 may be a controller area network (CAN), an Ethernet network, a wireless communications network, another type of communications network, or a combination of different communication networks. VCU 106 is also communicatively coupled to a positioning system 110 (e.g., a satellite navigation system), a user interface system 112, and a transceiver 114. Transceiver 114 is communicatively coupled to antennas 116, through which vehicle 102 can wirelessly transmit data to, and receive data from, wireless access device 150, as well as other systems (e.g., LAN access points, WAN access points, other vehicles, security servers, remote maintenance systems, etc.). In embodiments, transceiver 114 is capable of transmitting and receiving wireless messages in a personal area network, such as a Bluetooth™, Bluetooth™ low energy (BLE), Zigbee, or other wireless personal area network, consistent with the discussion herein. In embodiments, transceiver 114 is further capable of transmitting and receiving wireless messages with network 130, such as by using local area network, wide area network, cellular communication (e.g., Long Term Evolution), or other messaging.

Components 101 are generally components of the systems of the vehicle 102. For example, components 101 can include adjustable seat actuator systems, power inverter systems, window control systems, electronic braking system systems, climate control systems, media systems, etc. Vehicle control unit (VCU) 106 is a controller including a microprocessor, memory, storage, and a communication interface with which it can communicate with components 101, positioning system 110, user interface 112, and transceiver 114 via network 107. In one embodiment VCU 106 is the vehicle's main computer, but in other embodiments it can be a component separate from the vehicle's main or primary computer.

In one embodiment, VCU 106 includes a vehicle customization manager 120 that is used for customizing one or more systems of a vehicle for an operator or other user of vehicle 102. In embodiments, vehicle customization manager 120 uses wireless access device 150, other wireless access device(s) (not shown), digital user identifications, etc. to identify one or more users of the vehicle and their position (e.g., driver, front seat passenger, left rear passenger, right rear passenger, etc.) within the vehicle 102, as discussed in greater detail below. Vehicle customization manager 120 may include processing logic executed by VCU 106 and/or other processing resources of vehicle 102 to customize one or more systems of the vehicle for any user within the vehicle, such as by supplying specific customizations associated with each user to systems associated with the specific user's position within the vehicle.

In embodiments, wireless access device 150 is initially enrolled with vehicle 102, and vehicle 102 is enrolled with wireless access device 150. In embodiments, wireless access device 150 enrollment may occur, for example, at a dealership, at a service center, or by a user that is enrolling a new wireless access device 150 for use with vehicle 102. During an enrollment process, communications are exchanged between vehicle 102 and wireless access device 150 to, for example, exchange vehicle and/or wireless access device 150 identifiers. Furthermore, user identifier(s) (e.g., login/password combinations, biometric identifier(s), other digital identifiers) may also be provided to vehicle 102 (e.g., during a registration process at a dealership, for enrolling a new wireless access device, etc.) and associated with the wireless access device(s) used by specific authorized users of vehicle 102. For example, a particular user and user identifier may be associated, by vehicle 102, with an identifier of a particular wireless access device, such as wireless access device 150. However, in embodiments, a user may authenticate themselves to the vehicle independently of the wireless access device 150, such as by providing a username and password, using a biometric authentication (e.g., facial, voice, fingerprint, etc. recognition performed by system of vehicle), or other technique for uniquely identifying different users of the vehicle. Furthermore, where specific authentications are used, such as for example, facial recognition using one or more cameras of the vehicle, the position of the user within vehicle 102 may be determined automatically by image data used for performing the facial recognition. In embodiments, vehicle 102, as well as vehicle customization server(s) 180, maintains an association between each user and one or more forms of authentication associated with each user (e.g., key fob identifiers used by the user, biometric identifiers of the user, a username and password, etc.).

In embodiments, a user identifier may be a cellular telephone number, a data string, etc. that is a globally unique identifier is maintained within the systems of the manufacturer of vehicle 102. That is, for example, each user is associated with a globally unique identifier so that vehicle 102, vehicle customization server(s) 180, and other systems of a manufacturer of vehicle 102 (e.g., other vehicle(s), other system server(s), etc.) can distinguish between different users, for example, to store and use data (e.g., customization data) based on globally unique identifiers. In embodiments, the globally unique identifier for each user may be determined by vehicle 102 based on their providing and/or authentication of a key fob identifier, biometric identifier, digital identifier, or other identifier associated with the globally unique user identifier. As discussed above, the globally unique identifier for each user may be established for use by systems of the vehicle's 102 manufacturer during an initial registration phase, such as that performed when a vehicle is purchased from the manufacturer or an authorized third party. However, the globally unique identifier may be established at a later time, such as using a web interface or application distributed by the manufacturer (or the manufacturer's authorized third party) of vehicle 102.

In one embodiment, wireless access device 150 initiates authentication with vehicle 102. In embodiments, the authentication includes exchanging wireless access device 150 and/or vehicle 102 identifiers, encryption keys, session parameters, negotiating communication protocols, etc. One embodiment of enrolling wireless access device 150 and then authenticating wireless access device 150 to vehicle is discussed in U.S. patent application Ser. No. 16/042,847, titled “SYSTEMS AND METHODS FOR A VEHICLE AUTHENTICATING AND ENROLLING A WIRELESS DEVICE,” filed Jul. 23, 2018, which is incorporated by reference in its entirety. In one embodiment, during authentication of the wireless access device 150 to vehicle 102, wireless access device 150 provides its identifier to vehicle 102.

In one embodiment, vehicle customization manager 120 utilizes the received wireless access device 150 identifier to determine a user and the user's globally unique identifier using the wireless access device 150. In embodiments, as discussed herein, a user may be associated with a wireless access device 150 by their globally unique identifier as a result of their registration to use the vehicle and/or by a later registration process. In embodiments, the association between globally unique identifiers and one or more wireless access device identifiers is stored by vehicle customization manager 120 in a memory of VCU 106 or other memory of vehicle 102. In embodiments, after authentication of wireless access device 150 to vehicle, other forms of user identifier (e.g., biometric identifiers captured by systems of the vehicle, username/password combinations verified by the vehicle, etc.) may also be used by vehicle customization manager 120 to determine a user's globally unique identifier. Additionally, upon access to vehicle 120, vehicle customization manager 120 may determine more than one user identifier for different vehicle occupants, and thus each occupant's associated globally unique identifier.

In embodiments, vehicle customization manager 120 utilizes the globally unique identifier to obtain vehicle customization options for each identified user, for example a user associated with wireless access device 150, a user identified using biometric information, etc. As will be discussed in greater detail herein, more than one user (e.g. globally unique identifier) may be associated with each wireless access device 150/wireless access device identifier. Therefore, in embodiments, vehicle customization manager 120 tracks one or more of a geolocation, time, and relative frequency of use of a vehicle for each vehicle access. Based on the tracking, as well as on explicit association specified by a user, vehicle customization manager 120 associates geolocations, time of operation, and occurrence of use with different globally unique identifiers of the users of vehicle 102. In embodiments, vehicle customization manager 120 then utilizes usage patterns (e.g., user X uses vehicle 95% of the time, user Y always operates vehicle at a specific geographic location, user Z operates vehicle after 9 PM, etc.) to distinguish between different users of the same wireless access device 150, for example, by selecting a globally unique identifier associated with the user having a highest relative frequency of vehicle usage, by selecting a globally unique identifier associated with the user that typically uses a vehicle at a specific location, a globally unique identifier associated with the user that uses a vehicle at a specific time, or based on a combination of factors. Additionally, specific user authentications via biometric data, login credentials, etc. may also be used to distinguish between different users of the same wireless access device 150.

After selecting from among potential users, vehicle customization manager 120 performs customization of one or more system of vehicle. As discussed herein, customization can include turning features on/off (e.g., using a lane maintenance system or not), adjusting characteristics of a vehicle system (e.g., setting a temperature of a climate control system), selecting among options provided by a system (e.g., selecting to use an economy operation mode as opposed to a sport mode), as well as other customizations. In embodiments, the vehicle customization and the vehicle customization settings applied to vehicle systems can include any configurable system controllable within the vehicle, including and not limited to, driver assistance systems (e.g., automated driving systems, lane maintenance systems, cruise control systems, automated braking systems, etc.), convenience systems (e.g., climate control settings, seat heater settings, etc.), user interface systems (e.g., applications to be initiated and displayed on user interface 112, system volume and alert preferences, etc.), as well as other systems (e.g., seat position, mirror position, etc.).

In embodiments, vehicle customization settings are obtained by vehicle customization manager 120 for a selected globally unique identifier (e.g., the single globally unique identifier associated with wireless access device's identifier 150, the globally unique identifier associated with a predicted user of a vehicle based on vehicle geolocation, time of use, frequency of use by different vehicle operators, or the globally unique identifier associated with a biometric, username/password combination, or other digital identifier) from a vehicle customization cache on vehicle 102 and/or from vehicle customization server(s) 180. In embodiments, vehicle customization manager 120 stores vehicle customization settings data indicative of one or more systems settings of vehicle 102. In embodiments, the stored vehicle customization settings can include active settings set by a user (e.g., when a user adjusts a vehicle system, such as moving a seat to a new position), passive settings (e.g., when a user accepts and uses a system as configured by a stored/default vehicle customization setting). In embodiments, these settings may be communicated to vehicle customization server(s) 180, which are stored in a memory of one or more of the servers 180 and associated with the globally unique identifier of the vehicle's user(s). In embodiments, these settings may also be stored locally by vehicle 102, such as in a data store managed by vehicle customization manager 120.

In one embodiment, a user is provided with control over what vehicle customization settings are stored locally and/or remotely. That is, a user may configure vehicle customization manager 120 (e.g., via user interface 112, via an application executing on wireless access device 150, etc.) to control which customization settings are to be stored locally, which are to be stored remotely, and which settings are/are not to be stored at all. That is, the user is able to maintain data control and/or privacy of vehicle customization settings based on their configuration of sharing, distribution, and usage of vehicle customization settings.

In embodiments, the vehicle customization settings stored locally (e.g., by vehicle customization manager 120 in local cache) and remotely (e.g., by one or more of the vehicle customization server(s) 180) may be different. In one embodiment, a user may configure which storage is used to store which customization settings. In another embodiment, local cached vehicle customization settings storage may be used to store a subset of settings (e.g., a predetermined number of settings, predefined/user selected settings, most frequency used, most impactful to driving performance, most used by a particular user, etc.), whereas remotely stored customization settings may provide a different subset of settings (e.g. a remainder of settings, all possible settings that could customize a vehicle, settings selected by a user for remote storage, settings for different vehicles, etc.).

In embodiments, vehicle customization manager 120 may, upon receiving a vehicle access request, locate locally stored vehicle customization settings associated with a selected globally unique identifier, request and receive vehicle customization settings from server(s) 180 using the selected globally unique identifier, or a combination of local and remote vehicle customization settings. In embodiments, the local and remote vehicle customization settings may be obtained by vehicle customization manager in serial (e.g., local before remote to improve efficiency in which customization occurs), as well as in parallel (e.g., obtain both at the same time). Furthermore, where different customization settings are stored locally at vehicle 102 and remotely at server(s) 180, the local storage may provide vehicle customization settings to enable some degree of vehicle customization regardless of whether vehicle 102 can access server(s) 180 via network 130 (e.g., the cached local settings providing a backup to remote settings).

In embodiments, vehicle customization manager 120 then performs vehicle customization with the obtained vehicle customization settings. In embodiments, vehicle customization manager 120 generates commands to the various vehicle systems to implement the associated vehicle customization settings. In embodiments, vehicle customization manager 120 obtains and begins vehicle customization during the wireless access device 150 authentication process. As a result, customization can occur as a user approaches vehicle 102 and/or initiates a request to access vehicle, so that the vehicle is customized upon the user's entry to vehicle and prior to initiation of operation of the vehicle.

Therefore, with the enrollment of a specific wireless access device 150 to vehicle 102, and establishment of a globally unique identifier for a user (e.g., by association with wireless access device 150, biometric identifier(s), login/password credentials, etc.), vehicle customization of vehicle 102 may occur efficiently and acutely each time the user attempts to access vehicle 102 using wireless access device 150. Furthermore, vehicle customization of other vehicles, may be based on the globally unique identifier so that other vehicles with capabilities and/or systems similar to vehicle 102 (e.g. loaners, fleet vehicles, newly purchase vehicles, etc.) may also be customized with relevant customization options to improve an operator's experience.

In embodiments, the local cached vehicle customization settings may be encrypted prior to storage (e.g., based on a vehicle key, user key, or other encryption key) to preserve privacy of those settings. For example, if customization settings from the cache stored in vehicle 102 were copied to another vehicle, the lack of the proper decryption key at the other vehicle would prevent the other vehicle from accessing the stored customization settings, which may contain sensitive user information. Additionally, the local cached vehicle customization settings may further enhance user privacy by associating local and/or remote storage of customization settings with an expiration time. In embodiments, unless extended or approved by a user, local and/or remote customization settings can be are deleted from the local cache and or a request for deletion of customization settings can be to vehicle customization server(s) 180 at the end of an expiration period. In embodiments, both the encryption and/or expiration of customization settings locally and remotely are configurable by a user (e.g., whether encryption is used, how long the expiration period is, whether to renew storage or extend an expiration period, what settings are stored locally and remotely, etc.). Additionally, a user may request deletion of vehicle customization settings from the local cache, remote storage, or a combination, configure encryption preferences, configure expiration times, etc. via an interface of the vehicle (e.g., deletion of local cache and a request is sent to server 180 to delete remotely stored customization settings), from a user interface of the wireless access device (e.g., a smartphone app providing access to customization configuration settings), from an interface to vehicle customization server(s) 180, or a combination of interfaces. Additionally, vehicle customization settings maintained at and/or distributed among vehicle customization server(s) 180 may also be encrypted using one or more keys associated with each server, as discussed herein.

In embodiments, as discussed herein, vehicle 102 may have more than one occupant, where one or more of the occupants are each associated with their own globally unique identifier. For example, a driver, a front seat passenger, and a back seat passenger may each be associated with their own globally unique identifier. In embodiments, vehicle 102 may determine each user's/occupant's globally unique identifier based on, for example, a wireless access device used by each user/occupant, based on digital/biometric identifiers captured and/or verified for each user, etc. Furthermore, vehicle 102 may determine a position of each user within vehicle, such as by detecting a location of a wireless access device 150 within vehicle, determining from where within the vehicle biometric data of a user is captured, determining from among different user interfaces at different locations in vehicle 102 a user entered login/password credentials, etc. In this embodiment, each user's globally unique identifier may then be associated with the user and that user's position within vehicle 102, such that position dependent customization settings may be obtained and applied for each user. For example, UserA may have customization settings stored locally and/or remotely for driver, front seat, and rear set positions within the vehicle. Thus, depending on the determined position of UserA, UserA's globally unique identifier can be used by vehicle access manager 120 to access position-dependent vehicle customization options when customizing select systems of vehicle 102 for the user.

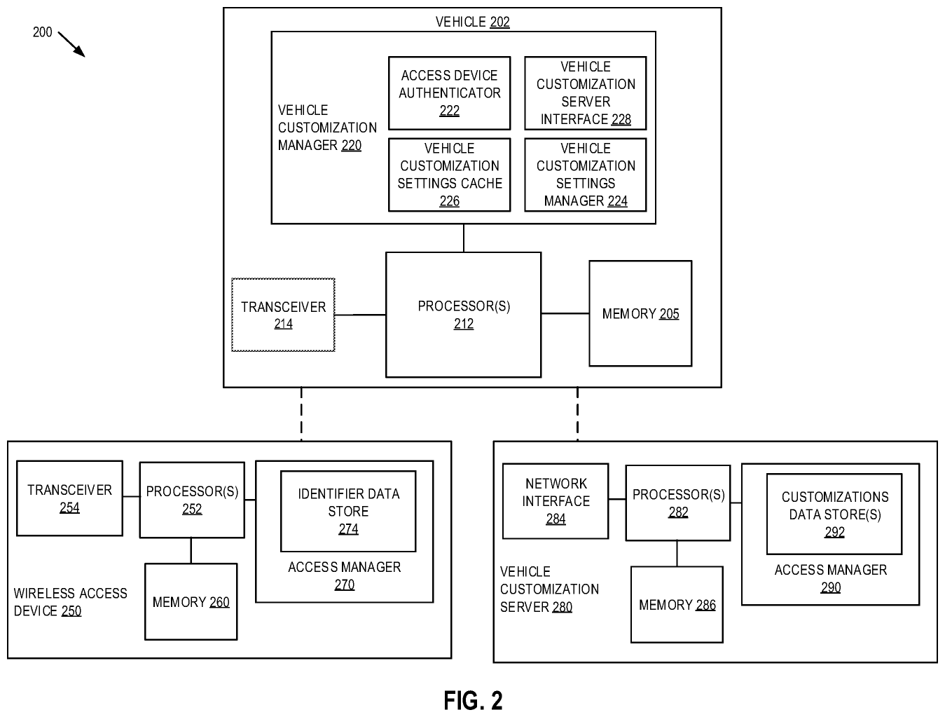

FIG. 2 is block diagram of one embodiment of a system 200 including a vehicle 202, a wireless access device 250, and a vehicle customization server 280. Vehicle 202, a wireless access device 250, and a vehicle customization server 280 provide additional details for vehicle 102, wireless access device 150, and vehicle customization server(s) 180 discussed above in FIG. 1.

In one embodiment, vehicle 202 is a system, which may include one or more processor(s) 212, a memory 205, and a transceiver 214. It should be appreciated that vehicle 202 may also include, although not illustrated, a user and/or hardware interface, vehicle controls, one or more power device(s) (e.g., vehicle battery, drive control system, one or more vehicle systems (e.g., VCUs, positioning systems, etc.) etc.), a propulsion system (e.g. an electric, gasoline, etc. powered motor), a steering system, a braking system, as well as other components typically associated with vehicles. It is to be understood that vehicle 202 may include a separate network interface (not shown) that may be capable of communicatively coupling vehicle 202 to any number of wireless subsystems (e.g., Bluetooth, WiFi, Cellular, or other networks), internal vehicle communication networks (e.g., a CAN bus, an Ethernet network, a wireless network, etc.) to transmit and receive data streams through one or more communication links. In embodiments, transceiver 214 may provide the network interface to various wireless subsystems.

In one embodiment, wireless access device 250 is also a wireless device, such as a key fob, smart phone, wearable device, etc., which may include one or more processor(s) 252, a memory 260, and a transceiver 254. In embodiments, transceiver 254 is a personal area network transceiver, such as a Bluetooth, BLE, Zigbee, or other personal area network transceiver. It should be appreciated that wireless access device 250 may also include, although not illustrated, a user interface (e.g., keyboard, touch-screen, or similar devices), a power device (e.g., a battery), a display screen (e.g., an LCD display), as well as other components typically associated with wireless devices. As discussed above, wireless access device 250 may be implemented in a purpose built device, or utilize the hardware and processing resources of a mobile telephone, wearable device, etc.

In one embodiment, vehicle customization server 280 is also a system, such as a desktop, server, laptop, or other computer processing system, which may include one or more processor(s) 282, a memory 286, and a network interface 284. In embodiments, network interface 284 enables vehicle customization server 280 to communicatively couple with a network, such as network 130. It should be appreciated that vehicle customization server 280 may also include, although not illustrated, a user interface (e.g., keyboard, touch-screen, or similar devices), a power device (e.g., a battery), a display screen (e.g., an LCD display), as well as other components typically associated with computer processing systems.

In embodiments, the memories (e.g., memory 205, memory 260, and memory 286) of vehicle 202, wireless access device 250, and vehicle customization server 280 may be coupled to processor(s) to store instructions for execution by the processors, such as processor (s) 212, processor(s) 252, and processor(s) 282. In some embodiments, the memory is non-transitory, and may store one or more processing modules. In one embodiment, memory 205 of vehicle 202 may store one or more processing modules of a vehicle customization manager 220, memory 260 of wireless access device 250 may store on or more processing modules of access manager 270, and memory 286 of vehicle customization manager 280 may store one or more processing modules of access manager 290 to implement embodiments described herein.

It should be appreciated that the embodiments as will be hereinafter described may be implemented through the execution of instructions, for example as stored in memory or other element, by processor(s) and/or other circuitry of vehicle 202, wireless access device 250, and vehicle customization server 280. Particularly, circuitry of vehicle 202, wireless access device 250, and vehicle customization manager 280, including but not limited to processor(s) 212, processor(s) 252, and processor(s) 282 may operate under the control of a program, routine, or the execution of instructions to execute methods or processes in accordance with the aspects and features described herein. For example, such a program may be implemented in firmware or software (e.g. stored in memory 205 and/or memory 260 and/or memory 286) and may be implemented by processors, such as processor(s) 212, processor(s) 252, and processor(s) 282, and/or other circuitry. Further, it should be appreciated that the terms processor, microprocessor, circuitry, controller, etc., may refer to any type of logic or circuitry capable of executing logic, commands, instructions, software, firmware, functionality and the like.

In one embodiment, vehicle 202 includes vehicle customization manager 202 for customization of systems of the vehicle 202. Access device authenticator 222 of vehicle customization manager 220 receives a request to authenticate/access wireless access device 250. In one embodiment, the request is generated by access manager 270 of wireless access device 250 and communicated wirelessly (e.g., via a personal area network connection) to vehicle 202. In embodiments, access manager 270 and access device authenticator 222 exchange a series of messages to authenticate wireless access device 250 to vehicle as a registered access device, exchange encryption keys, negotiate communication protocols and parameters, etc., as discussed in greater detail in U.S. patent application Ser. No. 16/042,847, titled “SYSTEMS AND METHODS FOR A VEHICLE AUTHENTICATING AND ENROLLING A WIRELESS DEVICE,” filed Jul. 23, 2018, which is incorporated by reference in its entirety. During the authentication, access manager 270 will provide a wireless device identifier from identifier data store 274 to access device authenticator 222 to identify the specific wireless access device seeking access to vehicle 202.

In embodiments, vehicle customization settings manager 224 utilizes the received wireless access device identifier to determine a globally unique identifier of a user associated with the wireless access device 250. In embodiments, after authentication of wireless access device 250 to vehicle 202, vehicle customization settings manager 224 may also utilize other forms of user identification (e.g., biometrics, log-in credentials, etc.) to determine a globally unique identifier of the user. Additionally, vehicle customization settings manager 224 may further determine globally unique identifiers of each user/occupant of the vehicle, as discussed above. As discussed herein, vehicle customization settings manager 224 looks up one or more globally unique identifier(s) associated with the received wireless access device identifiers, biometric identifiers, etc. in vehicle customization settings cache 226. When more than one globally unique identifiers are found to be associated with the access device identifier, vehicle customization settings manager 224 predicts the likely globally unique identifier/user seeking to access the vehicle 202 using wireless access device 250. As discussed herein, this can include determining a current geolocation of vehicle 202, determining a time, determining a relative frequency with which different users associated with the access device identifier seek to access the vehicle, or a combination thereof, compare to historical/tracked results, and select a most likely user (e.g., based on relative access frequency, based on likely access geolocation, based on time of data associated with user accesses, etc.).

Once the globally unique identifier for the user seeking to access the vehicle, which is associated with the wireless access device identifier 250 and/or other user identifier, is determined, vehicle customization settings manager 225 obtains one or more vehicle customization settings. In embodiments, the vehicle customization settings may be loaded from vehicle customization settings cache 226 and/or obtained via request to customizations data store(s) 292 at vehicle customization server 280. In embodiments, settings may be obtained from vehicle customization settings cache 226 initially and/or when vehicle 202 cannot establish network connection with server 280. Furthermore, the locally stored settings may be used to perform an initial customization in a first time frame, while remotely stored customization settings are being obtained in a second time frame. That is, the local customization options may quickly perform a first set of customizations (e.g., seat position, climate control settings, user interface configuration, and other settings a user may initially use when starting operation of a vehicle and which may be performed before a user accesses the vehicle), while a second set of customizations (e.g., driver control systems, GPS updates, etc. are obtained and used when a user begins operating the vehicle and after access to the vehicle). Furthermore, as discussed herein, what settings are stored, what settings are distributed between local and remote storage, etc. is configurable by a user so that the user maintains control over their customization settings. In embodiments, as discussed herein, vehicle customization settings manager 225 may also obtain local and/or remotely stored vehicle customization settings for each user/occupant of vehicle 202 which is associated with a globally unique identifier.

Vehicle customization settings manager 224 then executes the obtained vehicle customization settings. In embodiments, execution of the settings includes generating commands to various vehicle systems to implement the vehicle customization settings (e.g., adjusting a seat position, set a temperature, define applications to be displayed on a user interface, set a driving mode, etc.) for each user at their determined location within the vehicle. As discussed herein, each user's position may be determined with a wireless access device position within the vehicle used to establish an associated user's globally unique identifier, based on where within the vehicle biometric data for a user was captured, based on which user interface within a vehicle received user login and password credentials, etc.

In embodiments, because vehicle customization settings are not static, any change to a vehicle customization setting during operation by a user of vehicle 202 is used by vehicle customization setting manager 224 to update the settings in vehicle customization cache 226 and/or customization(s) data store 292. In embodiments, the updating can be based on user consent to change a customization setting (e.g., a setting changed during vehicle operation), and/or based on user configuration as to what customization settings are to be stored where (e.g. specific settings selected for storage locally in cache 226 or remotely in data store(s) 292). In embodiments, the globally unique identifier is referenced during the updating in both the local vehicle cache 226 and remote data store(s) 292 so that the settings are updated for the correct user.

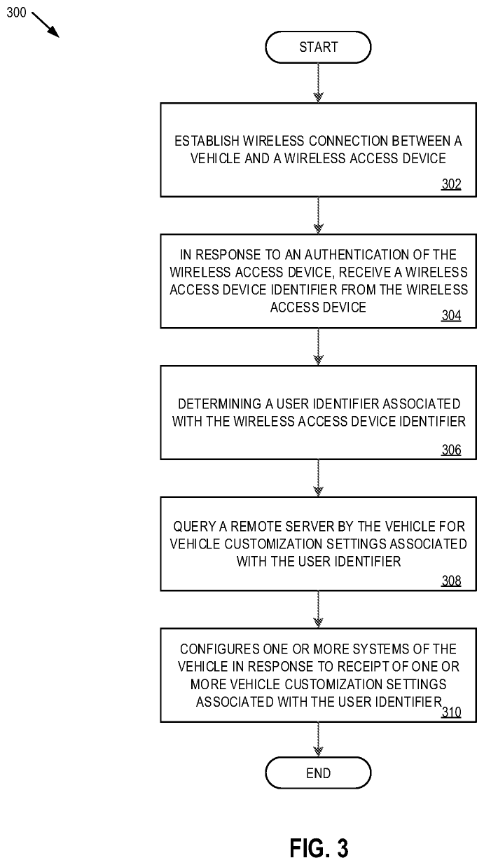

FIG. 3 is a flow diagram of one embodiment of a method for performing vehicle customizations for one or more users of a vehicle. The method 300 is performed by processing logic that may comprise hardware (circuitry, dedicated logic, etc.), software (such as is run on a general purpose computer system or a dedicated machine), firmware, or a combination. In one embodiment, the method 300 is performed by a vehicle customization manager (e.g., vehicle encryption manager 120 or 220 of vehicle 102 or 202). In embodiments, the processing logic of FIG. 3 may perform the process discussed herein for each detected user within a vehicle so that systems associated with each user and that user's position within the vehicle may be customized consistent with the discussion herein.

Referring to FIG. 3, processing logic begins by establishing a wireless connection between a vehicle and a wireless access device (processing block 302). In embodiments, and as discussed herein, the vehicle and the wireless access device form a personal area network connection in response to the wireless access device seeking to access the vehicle. This wireless network connection enables the vehicle and the wireless access device to exchange communications for authenticating the wireless access device to the vehicle, such as the exchange of identifiers, encryption keys, encryption tests, session protocols, etc.

In response to an authentication of the wireless access device, processing logic receives a wireless access device identifier from the wireless access device (processing block 304). The wireless device identifier, as discussed herein, identifies the specific device seeking to access the vehicle, and may be a media access control identifier, or other identifier for uniquely identifying different devices. Processing logic then determines a user identifier associated with the wireless access device identifier (processing block 306). As discussed herein, more than one user may be associated with each wireless access device. Therefore, in embodiments, processing logic utilizes additional factors, such as time access is being sought, geolocation of vehicle when access is being sought, a relative frequency with which different users seek to access the vehicle, or a combination of factors, which are compared with historically tracked data (e.g. where and when specific users typically access the vehicle, what user is the most frequent vehicle user, etc.). Based on comparison results, a most likely user may be selected when there are user identifiers associated with a received wireless access device identifier. In another embodiment, the user identifier may alternatively be determined based on biometric identification of a specific user, based on user supplied log-in and password credentials, or other digital identification of a specific user.

Processing logic then queries a remote server by the vehicle for vehicle customization settings associated with the user identifier (processing block 308). As discussed herein, each user identifier is a globally unique identifier that enables a manufacturer of vehicle to distinguish between each distinct user. Thus, the remote server is able to respond with specific vehicle customization settings for a user regardless of where and what vehicle the identified user is seeking to access.

Processing logic then configures one or more systems of the vehicle in response to receipt of one or more vehicle customization settings associated with the user identifier (processing block 310). In embodiments, processing logic generates one or more system commands, each being associated with the obtained customization options, to the relevant vehicle systems to implement the customization. For example, the command can include adjusting a seat position, height, decline angle, etc. communicated to actuators for an electronically controlled seat. As another example, the command can include setting options in GUI to select how elements are arranged in a GUI, what apps are launched at vehicle startup, etc. As yet another example, settings within launched apps may be set, such as what station a radio should be set to, a specific streaming music option within a music app, etc. Any system of the vehicle that may be configured, adjusted, or otherwise customized may be configured as discussed herein using vehicle customization settings.

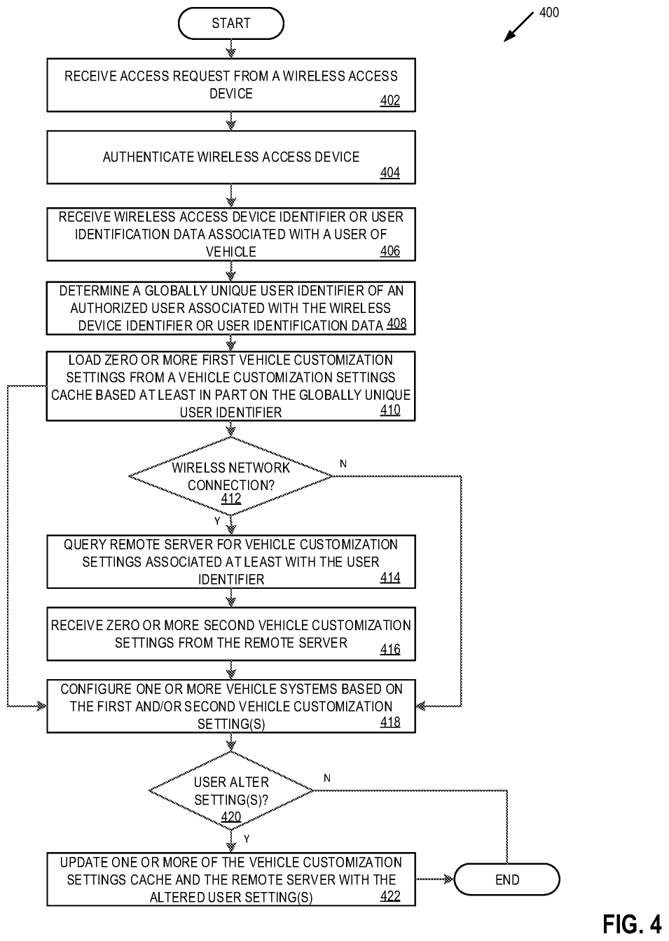

FIG. 4 is a flow diagram of another embodiment of a method for performing vehicle customizations using a wireless access device. The method 400 is performed by processing logic that may comprise hardware (circuitry, dedicated logic, etc.), software (such as is run on a general purpose computer system or a dedicated machine), firmware, or a combination. In one embodiment, the method 400 is performed by a vehicle customization manager (e.g., vehicle encryption manager 120 or 220 of vehicle 102 or 202). Similar to the discussion above, the processing logic of FIG. 4 may also perform the process discussed herein for each detected user within a vehicle so that systems associated with each user and that user's position may be customized consistent with the discussion herein.

Referring to FIG. 4, processing logic begins by receiving an access request from a wireless access device (processing block 402). In embodiments, the wireless access device may be a key fob seeking access to vehicle in response to a user depressing a button on the key fob. In another embodiment, the wireless access device may be a smartphone, wearable computing device, or other computer processing system seeking to access the vehicle in response to a user interacting with an app running on the wireless access device. As discussed herein, the access request is received in a wireless message, and establishes a wireless network connected used by processing logic to authenticate the wireless access device (processing block 404). In embodiments, the wireless access device is authenticated by verifying that a device identifier is associated with a device registered with the vehicle, supplying expected encryption keys, performing encryption tests, as well as other authentication factors to ensure that the wireless access device is indeed a device authorized to access the vehicle.

Processing logic receives, after or as part of the authentication process, a wireless access device identifier or user identification data associated with a user of the vehicle (processing block 406). This identifier may be a unique identifier established by a manufacturer of the wireless access device, as well as a device identifier generated by a manufacturer of the vehicle and distributed to the wireless access device. Furthermore, the user identification data may be received by processing logic in response to a biometric, digital, log-in/password verification, or other authentication of a user of the vehicle.

Processing logic then determines a globally unique user identifier of an authorized user associated with the wireless access device identifier or the user identification data (processing block 408). In embodiments, users register with a manufacturer of the vehicle, such as during purchase of the vehicle, adding a driver as an authorized driver by a vehicle owner, etc. As part of this registration, globally unique user identifiers are established by the manufacturer of the vehicle, so that any system of the manufacturer can accurately and uniquely identify each registered user. In embodiments, the globally unique identifier is stored in a secure storage (e.g. encrypted, tamper proof memory, etc.) of vehicle and associated with wireless device identifiers and other user identifiers (e.g. biometric identifiers, digital identifiers, additional wireless device identifiers, etc. of the user). Thus, processing logic is able to determine the globally unique user identifier based on this association in the memory of vehicle in response to receipt of the wireless access device identifier and/or user identification data during/after the authentication process.

Processing logic loads zero or more first vehicle customization settings from a vehicle customization settings cache based at least in part on the globally unique user identifier (processing block 410). In embodiments, the cache is checked for vehicle customization setting because network connectivity is not required and/or is faster than requesting data from a remote server. Furthermore, because there may be more than one user/globally unique identifier associated with a wireless access device identifier, processing logic may also predict and select from among different potential users based on access location, access time, relative frequency of access associated with authorized user, or a combination of factors. Once the specific user is determined, that user's globally unique identifier may be used as a reference to any vehicle customization settings stored locally at the vehicle (e.g., in the vehicle customization settings cache). In embodiments, the locally stored customization settings are referred to as first vehicle customization setting because the specific settings, and systems that are customized, stored locally and remotely may be different, based usage of such settings, user configuration, user opt in to store setting(s) remotely, etc.

Processing logic then determines if a wireless network connection, such an LTE or other telecommunications/computer network connection, is available (processing block 412). That is, when no connection is available, processing logic need not query a remote server for settings stored thereon. In embodiments, when a network connection is not available, processing logic may periodically check for the establishment of the connection to obtain the remotely stored customization options when a connection is determined to be available.

When a wireless network connection is available, processing logic queries a remote server for vehicle customization settings associated at least with the user identifier (processing block 414). In embodiments, additional data, such as a vehicle identifier, model identifier, etc., is also provided in the query so that relevant customization options, associated with the user identifier, may be selected by the remote server. For example, the same user may access two different vehicles using the same wireless access device. In this example, different customization options for each vehicle may be associated with the user by the user identifier as well as one or more identifiers for the different vehicles.

Processing logic receives zero or more second vehicle customization settings from the remote server (processing block 416). As discussed herein, the settings from the remote server may be for different vehicle systems than those accessed in the local cache. Processing logic configures one or more vehicle systems based on the first and/or second vehicle customization settings (processing block 418).

When processing logic determines that a user has altered one or more of the systems associated with a customization setting (processing block 420), processing logic updates one or more of the vehicle customization settings cache and the remote server with the altered user setting(s) (processing block 422). In embodiments, and during operation of the vehicle, a user may adjust their seat position, change a radio station, rearrange elements in a graphical user interface, set an internal temperature, turn off a seat heater, etc. Each of the changes discussed herein, as well as changes to other systems, may be associated with vehicle customization setting data, stored locally at the vehicle or remotely at a remote server. In embodiments, when such a change occurs, processing logic may automatically update the customization setting, by updating stored values in the cache and/or communicating an update request to change the value stored at the remote server. In another embodiment, the storage of the update customization setting values may be predicated on user consent to update the values. In yet another embodiment, based on user configurations as to what customization settings are to be stored where, when customization settings are to be updated, etc. only a subset of altered customization options may be distributed among the different systems, as discussed herein.

A discussed herein, systems of a vehicle may be customized for different users, such a customization of driving systems, customization of convenience systems, customization of climate control systems, customization of user interface systems, etc. Furthermore, the customizations may be associated with globally unique user identifiers, which enable consistent application of customization options across different vehicles used by specific users (e.g., the user's own vehicle, loaner vehicles, work vehicles, etc.). Furthermore, the customization options may be maintained locally by a vehicle, to quickly perform one or more vehicle customizations, and may also be maintained remotely to store additional customization option. These remotely stored customization options may be distributed to new vehicles accessed by a uniquely identified user (e.g., by their globally unique identifier). Furthermore, a user may configure how customization data is stored locally and/or remotely to provide the user with control over their data, provide transparency as to where the data is stored and how the data is used. As such, the user's experience in their own vehicle, as well as other vehicles, is greatly improved.

Those of skill would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the methods, systems, and apparatus of the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for customizing a vehicle for one or more users of the vehicle, the method comprising:
determining a user identifier associated with a user accessing the vehicle;
querying a remote server by the vehicle for first vehicle customization settings associated with the user identifier; and
configuring one or more systems of the vehicle in response to receipt of one or more vehicle customization settings from the remote server, the one or more vehicle customization settings being associated with the user identifier.

2. The method of claim 1, further comprising:
querying a cache memory of the vehicle to determine whether second vehicle customization settings associated with the user identifier are stored locally at the vehicle; and
configuring one or more systems of the vehicle with one or more vehicle customization settings from the cache memory.

3. The method of claim 2, wherein the querying of the cache memory is performed prior to the querying of the remote server.

4. The method of claim 2, wherein the querying of the cache memory is performed in parallel with the querying of the remote server.

5. The method of claim 2, wherein one or more vehicle customization settings of the first vehicle customization settings are different from one or more vehicle customization settings of the second vehicle customization settings.

6. The method of claim 2, further comprising:
establishing a wireless connection between the vehicle and a wireless access device;
in response to an authentication of the wireless access device by the vehicle, receiving a wireless access device identifier from the wireless access device over the wireless connection; and
determining the user identifier based on an association between the user identifier and the wireless access device identifier received form the wireless access device.

7. The method of claim 6, wherein a plurality of users are associated with the wireless access device, further comprising:
detecting one or more of a current geolocation of the vehicle and a time associated with a requested user access to the vehicle;
selecting a user from the plurality of users based at least in part on the current geolocation of the vehicle, the time associated with the requested user access to the vehicle, a frequency of user access to the vehicle by the user, or a combination thereof; and
using, based on the selection of the user form the plurality of users, a user identifier associated with the selected user identifier as the user identifier for querying the cache memory.

8. The method of claim 7, further comprising:
for each access to the vehicle, determining one or more of a geolocation of the vehicle, a time associated with each access, and a user identifier associated with a user determined to be accessing the vehicle;
storing, for each user, data indicative of where said each user accesses the vehicle, a frequency with which said each user accesses the vehicle relative to a remainder of each of the plurality of users, a time when said each user accesses the vehicle; and
selecting the user from the plurality of users based on a comparison of the data with the detected current geolocation of the vehicle, the detected time associated with the requested user access to the vehicle, a frequency with which the user accesses the vehicle relative to the remainder of the plurality of users.

9. The method of claim 6, wherein the wireless access device is one of a key fob, a mobile telephone, or a smart watch.

10. The method of claim 2, further comprising:
verifying user identification data associated with a user of the vehicle; and
in response to the verifying, determining the user identifier based on an association between the user identifier and the verified user identification data.

11. The method of claim 10, wherein verifying comprises:
performing a biometric verification of biometric data obtained from the user, determine whether a user name and password received from the user are valid, or combination thereof to obtain the user identification data.

12. The method of claim 2, further comprising:
detecting a user initiated change to one of the configured one or more systems of the vehicle;
updating a vehicle customization setting, associated with the user identifier, for the one of the configured one or more systems of the vehicle based on the detected user initiated change; and
distributing the updated vehicle customization setting with an association to the user identifier to the cache memory, the remote server, or a combination thereof.

13. The method of claim 2, wherein one or more of storage of the vehicle customization settings associated with the user identifier at the remote server, storage of the second vehicle customization settings associated with the user identifier in the cache memory, and vehicle customization settings of the first vehicle customization settings and the second vehicle customization settings used by the vehicle to configure systems of the vehicle are configurable in response to user selections.

14. The method of claim 1, wherein the configuring of the one or more systems of the vehicle is initiated by the vehicle prior to entry into the vehicle by the user associated with the user identifier.

15. The method of claim 1, further comprising:
determining a position of the user within the vehicle, wherein the position comprises a position associated with the user being a driver, a front seat passenger, a left back seat passenger, or a right back seat passenger;
querying the remote server by the vehicle for the first vehicle customization settings associated with the user identifier and the determined position of the user within the vehicle; and
configuring a first set of the one or more systems of the vehicle in response to receipt of one or more vehicle customization settings from the remote server, the one or more vehicle customization settings being associated with the user identifier and the determined position of the user within the vehicle.

16. The method of claim 15, wherein the position of the user is determined based on: a first determined position within the vehicle of a wireless access device used by the user to access the vehicle, a second determined position from which biometric data was obtained from the user, a third determined position from which user log-in and password data was input into a user interface of the vehicle, or combination thereof.

17. The method of claim 15, further comprising:
determining a second identifier for a second user accessing the vehicle;
determining a second position of the second user within the vehicle, wherein the position of the user and the second position of the second user are different;
querying the remote server by the vehicle for second vehicle customization settings associated with the second user identifier and the determined second position of the second user within the vehicle; and
configuring the first set of the one or more systems of the vehicle in response to receipt of the one or more vehicle customization settings from the remote server associated with the user identifier, and configuring a second set of the one or more systems of the vehicle in response to receipt of one or more second vehicle customization settings from the remote server associated with the second user identifier.

18. A non-transitory machine readable storage medium having instructions stored thereon, which when executed by a processing system of a vehicle, causes the processing system to perform one or more operations for customizing a vehicle for one or more users of the vehicle, the operations comprising:
determining a user identifier associated with a user accessing the vehicle;
querying a remote server by the vehicle for first vehicle customization settings associated with the user identifier; and
configuring one or more systems of the vehicle in response to receipt of one or more vehicle customization settings from the remote server, the one or more vehicle customization settings being associated with the user identifier.

19. The non-transitory machine readable storage medium of claim 18, further comprising:
querying a cache memory of the vehicle to determine whether second vehicle customization settings associated with the user identifier are stored locally at the vehicle; and
configuring one or more systems of the vehicle with one or more vehicle customization settings from the cache memory.

20. The non-transitory machine readable storage medium of claim 19, wherein one or more vehicle customization settings of the first vehicle customization settings are different from one or more vehicle customization settings of the second vehicle customization settings.

21. The non-transitory machine readable storage medium of claim 19, further comprising:
establishing a wireless connection between the vehicle and a wireless access device;
in response to an authentication of the wireless access device by the vehicle, receiving a wireless access device identifier from the wireless access device over the wireless connection; and
determining the user identifier based on an association between the user identifier and the wireless access device identifier received form the wireless access device.

22. The non-transitory machine readable storage medium of claim 21, wherein a plurality of users are associated with the wireless access device, further comprising:
detecting one or more of a current geolocation of the vehicle and a time associated with a requested user access to the vehicle;
selecting a user from the plurality of users based at least in part on the current geolocation of the vehicle, the time associated with the requested user access to the vehicle, a frequency of user access to the vehicle by the user, or a combination thereof; and
using, based on the selection of the user form the plurality of users, a user identifier associated with the selected user identifier as the user identifier for querying the cache memory.

23. The method of claim 22, further comprising:
for each access to the vehicle, determining one or more of a geolocation of the vehicle, a time associated with each access, and a user identifier associated with a user determined to be accessing the vehicle;
storing, for each user, data indicative of where said each user accesses the vehicle, a frequency with which said each user accesses the vehicle relative to a remainder of each of the plurality of users, a time when said each user accesses the vehicle; and
selecting the user from the plurality of users based on a comparison of the data with the detected current geolocation of the vehicle, the detected time associated with the requested user access to the vehicle, a frequency with which the user accesses the vehicle relative to the remainder of the plurality of users.

24. The non-transitory machine readable storage medium of claim 19, further comprising:
verifying user identification data associated with a user of the vehicle; and
in response to the verifying, determining the user identifier based on an association between the user identifier and the verified user identification data.

25. The non-transitory machine readable storage medium of claim 19, further comprising:
detecting a user initiated change to one of the configured one or more systems of the vehicle;
updating a vehicle customization setting, associated with the user identifier, for the one of the configured one or more systems of the vehicle based on the detected user initiated change; and
distributing the updated vehicle customization setting with an association to the user identifier to the cache memory, the remote server, or a combination thereof.

26. The non-transitory machine readable storage medium of claim 18, wherein the configuring of the one or more systems of the vehicle is initiated by the vehicle prior to entry into the vehicle by a user associated with the user identifier.

27. The non-transitory machine readable storage medium of claim 18, further comprising:
determining a position of the user within the vehicle, wherein the position comprises a position associated with the user being a driver, a front seat passenger, a left back seat passenger, or a right back seat passenger;
querying the remote server by the vehicle for the first vehicle customization settings associated with the user identifier and the determined position of the user within the vehicle; and
configuring a first set of the one or more systems of the vehicle in response to receipt of one or more vehicle customization settings from the remote server, the one or more vehicle customization settings being associated with the user identifier and the determined position of the user within the vehicle.

28. The non-transitory machine readable storage medium of claim 27, wherein the position of the user is determined based on: a first determined position within the vehicle of a wireless access device used by the user to access the vehicle, a second determined position from which biometric data was obtained from the user, a third determined position from which user log-in and password data was input into a user interface of the vehicle, or combination thereof.

29. The non-transitory machine readable storage medium of claim 27, further comprising:
determining a second identifier for a second user accessing the vehicle;
determining a second position of the second user within the vehicle, wherein the position of the user and the second position of the second user are different;
querying the remote server by the vehicle for second vehicle customization settings associated with the second user identifier and the determined second position of the second user within the vehicle; and
configuring the first set of the one or more systems of the vehicle in response to receipt of the one or more vehicle customization settings from the remote server associated with the user identifier, and configuring a second set of the one or more systems of the vehicle in response to receipt of one or more second vehicle customization settings from the remote server associated with the second user identifier.

30. A system for customizing a vehicle for one or more users of the vehicle, comprising:
a plurality of system of the vehicle;
a transceiver;
a memory to store user identifiers associated with users authorized to access the vehicle;
a processing system coupled with the memory and the transceiver configured to:
determine a user identifier from the memory that associated with a user accessing the vehicle,
query, using the transceiver, a remote server for first vehicle customization settings associated with the user identifier, and
configure one or more of the plurality of systems of the vehicle in response to receipt of one or more vehicle customization settings from the remote server, the one or more vehicle customization settings being associated with the user identifier.

31. The system of claim 30, further comprising the processor configured to:
query a cache memory of the vehicle to determine whether second vehicle customization settings associated with the user identifier are stored locally at the vehicle; and
configure one or more systems of the vehicle with one or more vehicle customization settings from the cache memory.

32. The system of claim 31, further comprising:
the transceiver configured to establish a wireless connection between the vehicle and a wireless access device; and
the processor configured to:
in response to an authentication of the wireless access device by the vehicle, receive from the transceiver a wireless access device identifier from the wireless access device over the wireless connection, and
determine the user identifier based on an association between the user identifier and the wireless access device identifier received form the wireless access device.
